(19) United States
(12) Patent Application Publication
(10) Pub. No.: US 2010/0059429 A1
(43) Pub. Date: Mar. 11, 2010

(54) FILTERING APPARATUS FOR POOL

(76) Inventors: William E. Barry, Mogadore, OH (US); Rosana L. Barry, Mogadore, OH (US)

Correspondence Address: Intellipex PLLC, 30200 Telegraph Road, Suite 245, Bingham Farms, MI, 48025, US

(21) Appl. No.: 12/555,019

(22) Filed: Sep. 8, 2009

Related U.S. Application Data
(60) Provisional application No. 61/191,703, filed on Sep. 11, 2008.

(51) Int. Cl. B01D 29/11; E04H 4/14

(52) U.S. Cl. 210/167.1

(57) ABSTRACT

A filtering apparatus, for preventing contaminants of water from entering a pool from a pool inlet having a screw-on cap, includes a stretchable elongated member and a securing member. The stretchable elongated member includes an open end portion, a closed end portion, and a body portion extending between the open end portion and the closed end portion. Further, the securing member is coupled to a periphery of the open end portion. The securing member is capable of being disposed on a peripheral edge of the pool inlet to enable removable coupling of the stretchable elongated member to the peripheral edge of the pool inlet via the screw-on cap for enabling accumulation of the contaminants of water in the stretchable elongated member.

### CROSS-REFERENCE TO RELATED APPLICATION

This application claims the benefit of U.S. Provisional Application No. 61/191,703 filed on Sep. 11, 2008 the disclosure of which is incorporated herein by reference.

### FIELD OF THE DISCLOSURE

The present disclosure generally relates to filtering apparatuses, and more particularly, to a filtering apparatus capable of preventing contaminants of water from entering a pool.

### BACKGROUND OF THE DISCLOSURE

Generally, in pools, such as swimming pools and spas, water get polluted from environmental contaminants that may come along with water during water circulation of the pools. The environmental contaminants typically include insects, leaves, twigs, debris, pollens, bacteria, viruses, algae, and the like. Such environmental contaminants are injurious from health perspective, and may cause diseases or infections to users of the pools. Accordingly, water entering the pools during the water circulation of the pool need to be sanitized to prevent ingress of such environmental contaminants.

Generally, water entering a pool is sanitized by utilizing a water circulation pump and a water filter. The water circulation pump circulates water through the water filter everyday, thereby preventing the environmental contaminants to enter in the pool. Specifically, such water filters retain large sized environmental contaminants therewithin while water passes through such water filters in the pool. However, such water filters are unable to retain some small sized environmental contaminants.

Such small sized environmental contaminants get released in the pool while water passes through such water filters in the pool, thereby polluting the pool. Accordingly, the user needs to manually remove such environmental contaminants, to keep water clean. For example, the user may utilize a leaf net to remove such environmental contaminants. Such manual sanitization of water consumes time and may require considerable efforts from the user.

### SUMMARY OF THE DISCLOSURE

One embodiment of a filtering apparatus for preventing contaminants of water from entering a pool from a pool inlet is provided. The pool inlet, to which the filtering apparatus may be coupled, may include a screw-on cap removably fastened over a periphery thereof. The filtering apparatus may include a stretchable elongated member, and a securing member. The stretchable elongated member may include an open end portion, a closed end portion, and a body portion extending between the open end portion and the closed end portion. The stretchable elongated member may be capable of accumulating the contaminants of water therein. Further, the securing member may be coupled to a periphery of the open end portion of the stretchable elongated member. The securing member may be capable of being disposed on a peripheral edge of the pool inlet to enable removable coupling of the stretchable elongated member to the peripheral edge of the pool inlet via the screw-on cap of the pool inlet. The removable coupling of the stretchable elongated member may enable the stretchable elongated member to prevent the contaminants of water from entering in the pool from the pool inlet.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 is an exploded view of an environment depicting a filtering apparatus and pool having a pool inlet, in accordance with an embodiment of the present disclosure; and

FIG. 2 is a perspective view an environment depicting an assembly of the filtering apparatus of FIG. 1 with the pool inlet of the pool, in accordance with an embodiment of the present disclosure.

Like reference numerals refer to like parts throughout the description of several views of the drawings.

### DETAILED DESCRIPTION OF THE DISCLOSURE

The exemplary embodiments described herein detail for illustrative purposes are subject to many variations in structure and design. It should be emphasized, however, that the present disclosure is not limited to a particular filtering apparatus, as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting. The use of terms, “including,” or “comprising,” and variations thereof herein is meant to encompass the items listed thereafter and equivalents thereof as well as additional items. Further unless limited otherwise, the terms “disposed,” “secured,” “coupled,” and variations thereof herein are used broadly and encompass direct and indirect attachments and arrangements. Furthermore, the terms “a” and “an” herein do not denote a limitation of quantity, but rather denote the presence of at least one of the referenced item.

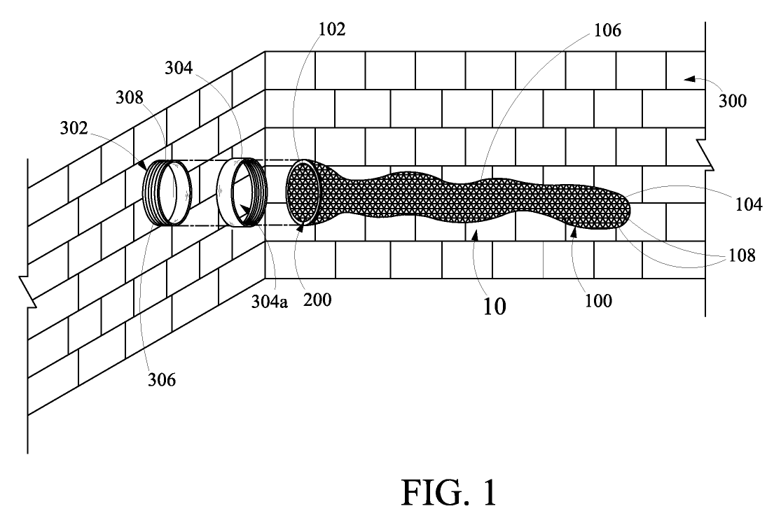

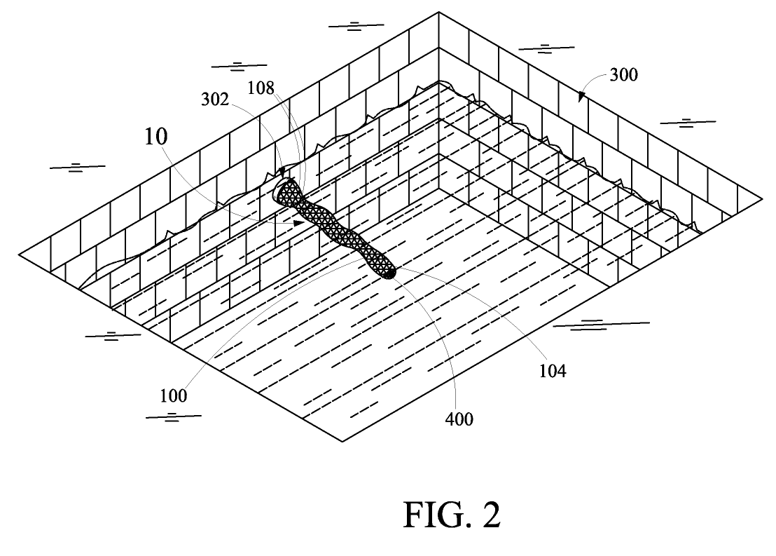

In one aspect, the present disclosure provides a filtering apparatus for preventing contaminants of water from entering a pool through a pool inlet. The term “pool” relates to a swimming pool, a spa, and the like. Further, the term “contaminants” relate to insects, leaves, twigs, debris, pollens, bacteria, viruses, algae, and the like. The filtering apparatus of the present disclosure is explained in detail in conjunction with FIGS. 1 and 2.

FIG. 1 illustrates an exploded view of an environment depicting a filtering apparatus 10 and a pool 300 having a pool inlet 302, in accordance with an embodiment of the present disclosure. Further, FIG. 2 illustrates a perspective view an environment depicting an assembly of the filtering apparatus 10 of FIG. 1 with the pool inlet 302 of the pool 300, in accordance with an embodiment of the present disclosure.

The filtering apparatus 10 includes a stretchable elongated member 100, and a securing member 200 (as depicted in FIG. 1) coupled to the stretchable elongated member 100. The stretchable elongated member 100 includes an open end portion 102, a closed end portion 104, and a body portion 106 extending between the open end portion 102 and the closed end portion 104. In one embodiment of the present disclosure, the stretchable elongated member 100 includes a plurality of yarns 108. The plurality of yarns 108 is stocked together to form a permeable stretchable elongated member, such as the stretchable elongated member 100. The stretchable elongated member 100 is capable of accumulating contaminants of water therein, and allows water that is substantially free from the contaminants to disperse therefrom. It will be evident to a person skilled in the art that the stretchable elongated member 100 may be made of any permeable material.

Further, the securing member 200 is coupled to a periphery of the open end portion 102 of the stretchable elongated member 100 (as depicted in FIG. 1). It will be evident to a person skilled in the art that the securing member 200 may be coupled to the periphery of the open end portion 102 by various means known in the art, such as gluing, stitching, and the like. It will also be evident to a person skilled in the art that the securing member 200 may be embedded to the periphery of the open end portion 102 either during manufacturing of the filtering apparatus 10, or may be coupled afterwards to the periphery of the open end portion 102 for obtaining a filtering apparatus, such as the filtering apparatus 10. In the present embodiment of the disclosure, the securing member 200 is an elastic band, however, it will be evident to a person skilled in the art that the securing member 200 may be any other suitable member know in the art.

The filtering apparatus 10 prevents the contaminants of water from entering the pool 300. Further as disclosed, the pool 300 includes the pool inlet 302. The pool inlet 302 includes a screw-on cap 304 removably fastened over a periphery 306 of the pool inlet 302. The screw-on cap 304 includes a cavity portion 304a. It will be evident to a person skilled in the art that though the present embodiment of the disclosure, illustrates the screw-on cap 304 to be removably fastened over the periphery 306 of the pool inlet 302, any suitable cap known in the art may be removably fastened over the periphery 306.

The pool inlet 302 of the pool 300 enables water to enter in the pool 300. Generally, water entering a pool, such as the pool 300, from a pool inlet, such as the pool inlet 302, passes through a main water filter system (not shown) of the pool before entering in the pool. Specifically, a water circulation pump (not shown) of the main water filter system circulates water through a main water filter (not shown) of the main water filter system for distilling the contaminants of the water in order to prevent the contaminants to enter in the pool, and then supplies the water in the pool through the pool inlet. However, the main water filter may be unable to prevent all the contaminants of water from entering the pool. Further, in various other types of pools, water may also be directly supplied in the pools from pool inlets thereof, without passing through any such main water filter system. In order to prevent the contaminants from entering in any of the described pools, the filtering apparatus 10 may be used. In the present embodiment of the disclosure, the filtering apparatus 10 prevents the contaminants of water from entering in the pool 300 along with water supplied from the main water filter, or supplied directly, without passing through any such main water filter.

As shown in FIG. 1, to prevent the contaminants of water from entering in the pool 300, the filtering apparatus 10 may be removably coupled to the pool inlet 302. Specifically, the securing member 200 of the filtering apparatus 10 is capable of being disposed on a peripheral edge 308 of the pool inlet 302. More specifically, a user may hold the filtering apparatus 10, and apply a specific force such that the securing member 200 gets stretched to comprehend the peripheral edge 308. Accordingly, the stretched securing member 200 may be then disposed on the peripheral edge 308 of the pool inlet 302 for enabling removable coupling of the stretchable elongated member 100 to the peripheral edge 308 of the pool inlet 302 via the screw-on cap 304.

The user, upon disposing the securing member 200 on the peripheral edge 308, may fasten the screw-on cap 304 over the periphery 306 of the pool inlet 302. Specifically, the stretchable elongated member 100 from the closed end portion 104 thereof may be received in the cavity portion 304a of the screw-on 304, and accordingly the screw-on cap 304 is slid towards the open end portion 102 of the stretchable elongated member 100 disposed on the peripheral edge 308 of the pool inlet 302. Further, the screw-on cap 304 may be fastened over the open end portion 102, thereby securing the stretchable elongated member 100 on the pool inlet 302. The screw-on cap 304 enables the filtering apparatus 10 to remain coupled to the pool inlet 302, when water flows in the pool 300 through the pool inlet 302. The securing member 200 and the screw-on cap 304 removably couple the stretchable elongated member 100 to the peripheral edge 308 of the pool inlet 302 for enabling the stretchable elongated member 100 to prevent the contaminants of water from entering the pool 300, as explained in conjunction with FIG. 2.

As shown in FIG. 2, the filtering apparatus 10 is coupled to the pool inlet 302. Water then supplied from a water source (not shown) passes through the pool inlet 302 and the filtering apparatus 10 for being collected in the pool 300. The stretchable elongated member 100 accumulates the contaminants, such as contaminants 400, of water passing therefrom. Further, the stretchable elongated member 100 allows water substantially free from the contaminants 400, to disperse therefrom for being collected in the pool 300. Further, when water supply from the water source is cut, the filtering apparatus 10 may be decoupled from the pool inlet 302 for disposing the contaminants 400 accumulated therein to use the filtering apparatus 10 for next cycle.

The present disclosure provides a filtering apparatus in one form, such as the filtering apparatus 10, for preventing contaminants of water from entering a pool from a pool inlet. Specifically, this filtering apparatus may accumulate the contaminants of water and allow water substantially free from the contaminants to disperse therefrom in the pool. Accordingly, the filtering apparatus may enable substantially sanitization of water entering in pool. Specifically, the filtering apparatus may substantially block the ingress of the contaminants in the pool. Further, the filtering apparatus may provide sanitization of water entering the pool in a manner that is easy and saves time. Furthermore, the filtering apparatus may prevent manual removal of the contaminants from the pool.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present disclosure.

What is claimed is:

1. A filtering apparatus for preventing contaminants from entering a pool through a pool inlet, the pool inlet comprising a screw-on cap removably fastened over a periphery thereof, the filtering apparatus comprising:
a stretchable elongated member comprising an open end portion, a closed end portion, and a body portion extending between the open end portion and the closed end portion, wherein the stretchable elongated member is capable of accumulating the contaminants of water therein; and
a securing member coupled to a periphery of the open end portion of the stretchable elongated member, the securing member capable of being disposed on a peripheral edge of the pool inlet,
wherein the securing member disposed on the peripheral edge of the pool inlet enables removable coupling of the stretchable elongated member to the peripheral edge of the pool inlet via the screw-on cap, thereby enabling the stretchable elongated member to prevent the contaminants of water from entering in the pool from the pool inlet.

2. The apparatus of claim 1, wherein the securing member is an elastic band.

3. The apparatus of claim 1, wherein the stretchable elongated member comprises a plurality of yarns, the plurality of yarns is stocked together to form a permeable stretchable elongated member capable of accumulating the contaminants of water therein, and allowing water substantially free from the contaminants to disperse therefrom.

4. The apparatus of claim 1, wherein the stretchable elongated member is made of a permeable material.
